(19) United States
(12) Patent Application Publication
(10) Pub. No.: US 2005/0274631 A1
(43) Pub. Date: Dec. 15, 2005

(54) Portable art pack

(76) Inventor: Virginia L. Martin, York, NY (US)

Correspondence Address: Stephen B. Salai, Esq.;Harter, Secrest & Emery LLP, 1600 Bausch & Lomb Place, Rochester, NY, 14604-2711, US

(21) Appl. No.: 11/127,861

(22) Filed: May 12, 2005

Related U.S. Application Data
(60) Provisional application No. 60/570,195, filed on May 12, 2004.

(51) Int. Cl. B44D 3/00; A45C 11/34; B65D 69/00

(52) U.S. Cl. 206/1.7; 206/214; 206/575

(57) ABSTRACT

An art pack with a continuous peripheral wall having an internal and an external side that are joined together at a spine such that the external side encompasses various pockets including a solid base for holding the artist's medium, and are reversible to form easel. The portable art pack is designed for a traveling artist to accommodate the needs of a watercolor, pastel, oil, acrylic, or pencil artist with the appropriate supplies and materials necessary to work in any location.

### BACKGROUND OF THE INVENTION

1. Field of the Invention

This invention generally concerns a portable art pack designed for the traveling artist. The pack is outfitted to accommodate the needs of watercolor, pastel, oil, acrylic, or pencil, so the artist has all the appropriate supplies and materials needed to work in any location.

2. Description of Related Art

Portable art easels, sometimes referred to as field easels, have been used for years but they are always bulky and necessitate the need for an accompanying bag of materials and supplies. The present invention solves this problem.

### BRIEF SUMMARY OF THE INVENTION

This invention is for an art pack that has a body with a continuous peripheral wall having an internal and an external side that are joined together such that the external side encompasses various pockets including a solid base for holding the artist's medium, such as paper or canvas and can be reversed to the internal side forming an easel. The portable art pack is designed for a traveling artist. The art pack is outfitted to accommodate the needs of a watercolor, pastel, oil, acrylic, pencil artist or other so that the artist has all the appropriate supplies and materials necessary to work in any location.

### BRIEF DESCRIPTION OF THE SEVERAL VIEWS OF THE DRAWING(S)

In the detailed description of the preferred embodiments of the invention presented below, reference is made to the accompanying drawings.

FIG. 1 is an expanded schematic drawing of the portable art pack.

FIG. 2 is a view of the portable art pack in the closed position.

FIG. 3 is a view of the portable art pack in an upright position.

FIG. 4 is a view of the portable art pack with openings visible.

FIG. 5 is a view of the portable art pack showing one of the leaves.

FIGS. 6a and 6b are views of the portable art pack showing two types of easels.

### DETAILED DESCRIPTION OF THE INVENTION

The present description will be particularly directed to elements forming a part of, or more directly in cooperation with, the portable art pack apparatus in accordance with the present invention. It is understood that elements not specifically shown or described may take various forms well known to those skilled in the art.

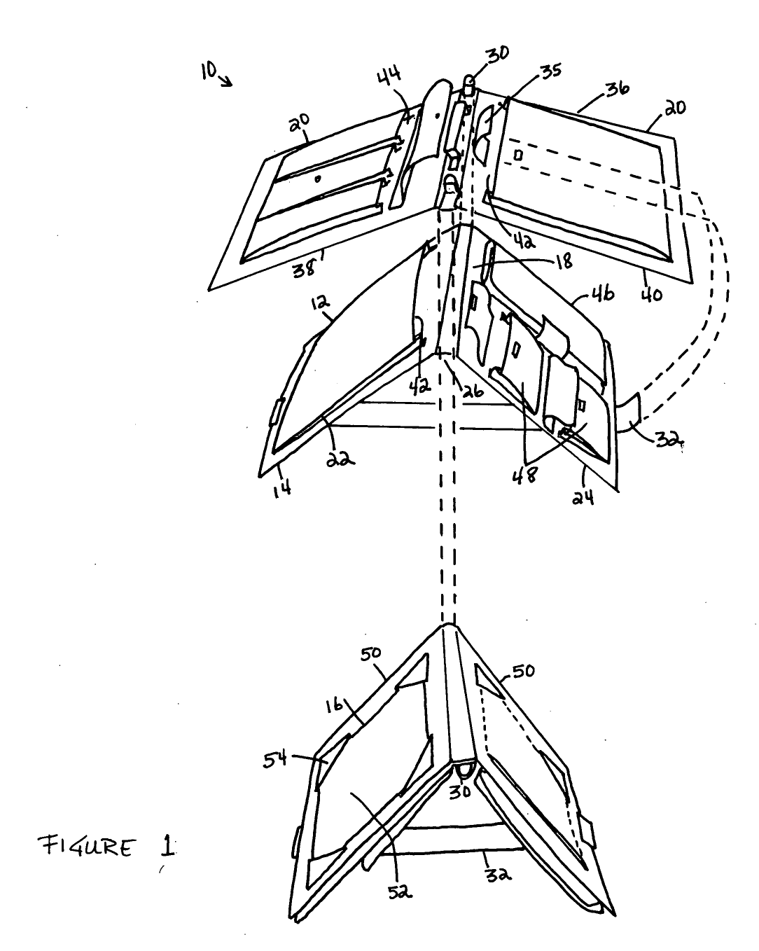

FIG. 1 is an expanded schematic drawing of a portable art pack 10. The art pack 10 has a main body 12 with a continuous peripheral wall 14. The main body 12 having an internal side 16 and an external side 18. The main body, hereafter referred to as the body 12, can support various other leaves or wings 20, as shown in this figure.

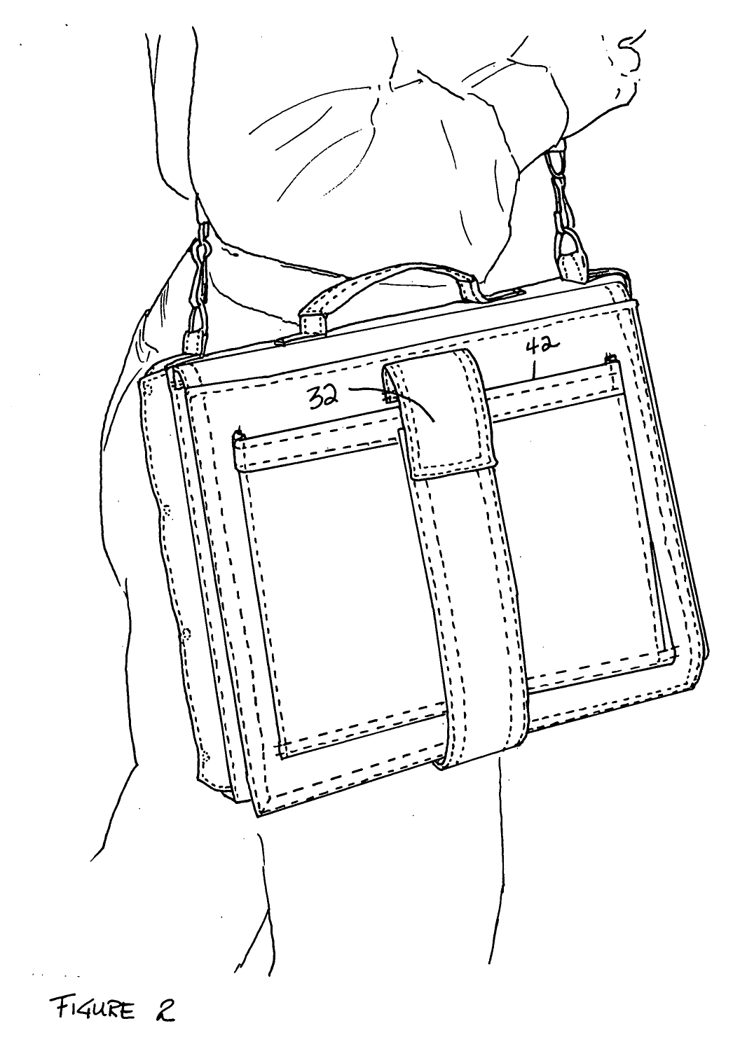

A first leaf 22 and a second leaf 24 of the body 12 are joined by a spine 26 such that the pack can be folded about a fold line between a first storage position, capable of being stored away as a pad, and a second upright position capable of forming one or more easels. The body 12 is shown in FIG. 1 with a handle 28 and a strap hook 30 for attaching a detachable shoulder strap shown in FIG. 2.

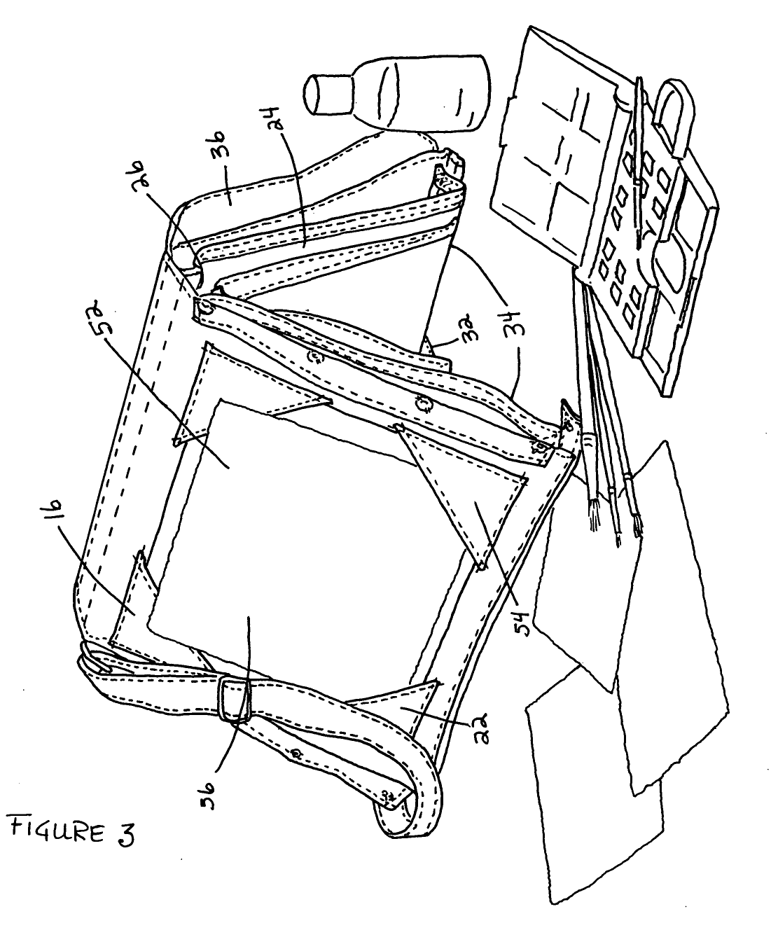

One or more closure flaps 32 extend from the first leaf 22 to the second leaf 24. The closure flap 32 has a first position to maintain the leaves in a first closed position as shown in FIG. 2, and a second position to maintain the leaves in a second upright position as shown in FIG. 3. The closure flap 32 limits an aperature 34 to less then 180 degrees, preferably between 40 and 120 degrees so that the body 12 makes an A-shape that forms a stand alone easel. These positions can be simply made by attaching one or more Velcro attachment pieces 35 to the leaf and/or strap to allow one or more closure positions. Other connectors such as snaps, hooks, buttons or more complex closure devices known in the art could be also used.

The portable art pack 10 can have other layers such as layer 36 shown in FIG. 1 with one or more leaves. The layer 36 shown in FIG. 1 has two additional leaves, a first leaf 38 and a second leaf 40 that are joined to the spine 26 such that these leaves overlap the first and second leaves of the main body 12. One skilled in the art would understand that the leaf could take any shape. The leaves of the second layer 36 are sewn into the main body 12 but they could just as well be detachable and/or could be joined by various connectors such as snaps, Velcro or hooks as well as string or a flexible material. All the leaves could be constructed from one continuous piece of material if desired. When a second layer is included the closure flap 32 can extend from the first leaf 22 to any of the other leaves such that the body can be folded to form the first storage position and the second supporting, upright position shown in FIG. 3 and still be capable of forming an easel as discussed above.

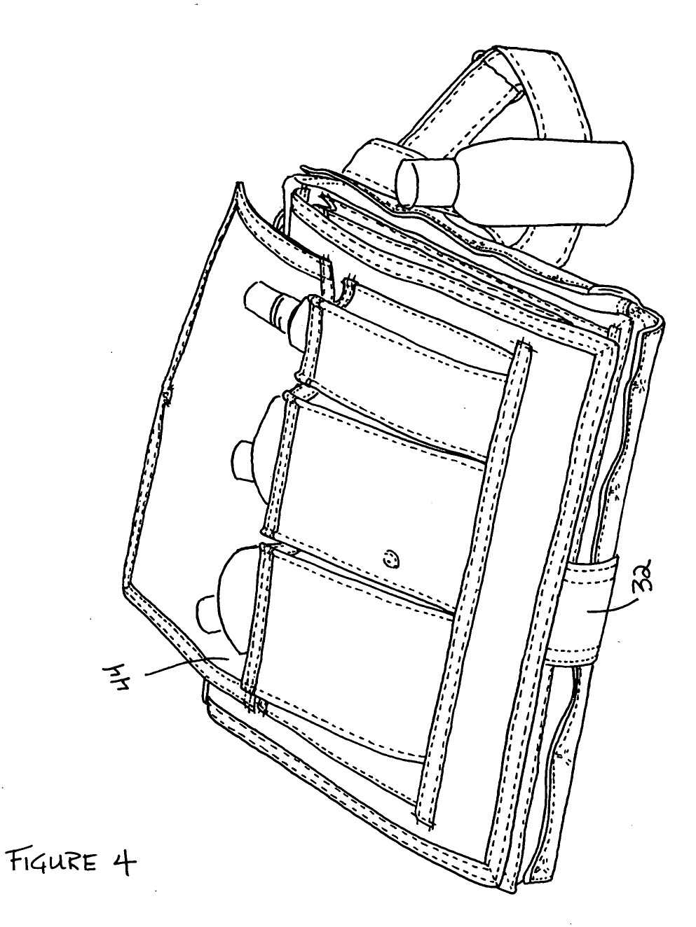

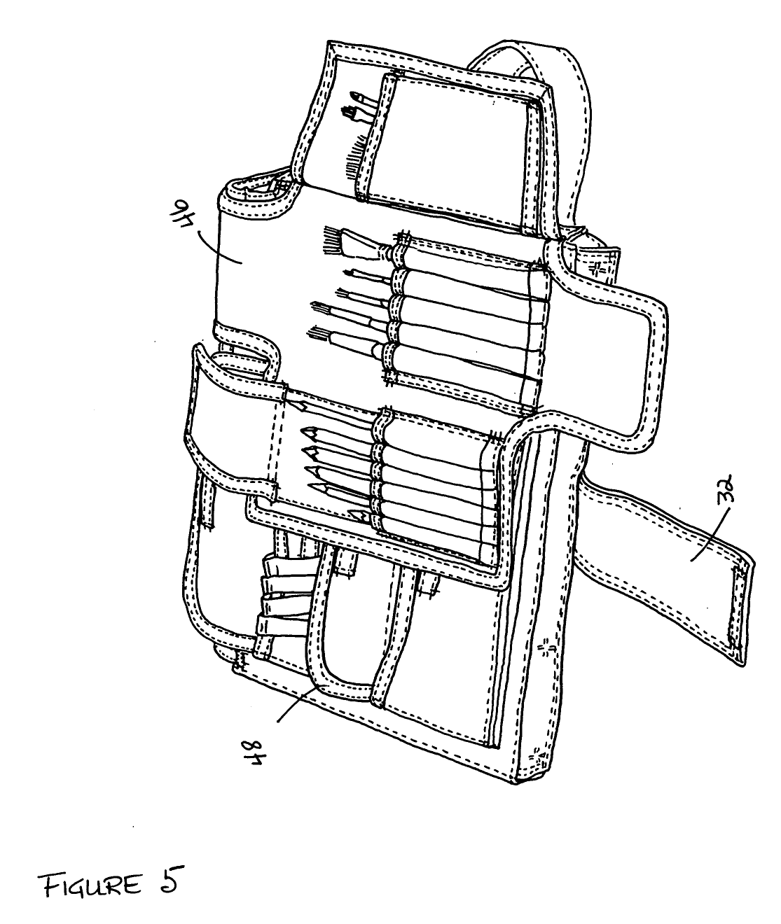

Each leaf can have more than one opening, 42, 44 as shown in FIGS. 2 and 4. One or more releasable holders 46 and/or pouches 48 can be attached to each leaf as shown in FIG. 5, so that various art supplies can be readily available to the artist.

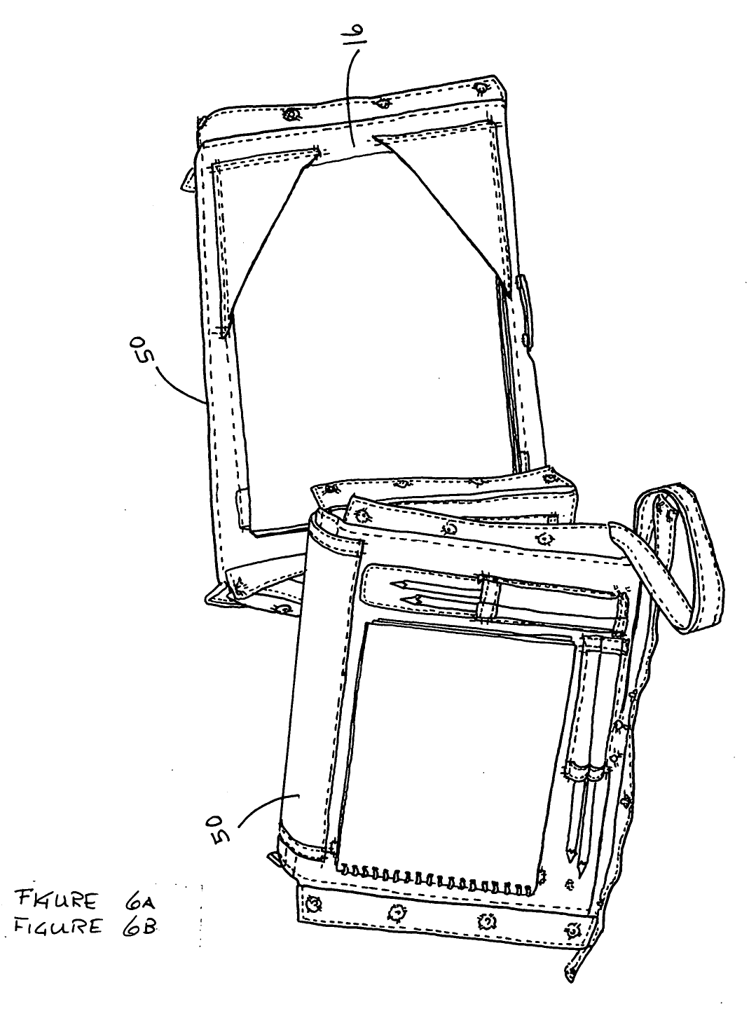

The internal side 16 of the body 12 is designed to form one or more easels 50, shown in FIGS. 6a and 6b. The easel is an integral part of the portable art pack that is revealed when the front portion of the art pack is folded backward upon itself. In this embodiment the portable art pack is made of a canvas or hard cloth or plastic material.

Referring to FIG. 3 a rigid insert 52 is shown on the internal side 16 of the body 12 held by gussets 44 that hold the medium 56 that will be used by the artist to create a piece of work, such as canvas or paper, for oil or watercolors as shown in FIG. 6b. The rigid insert can be a flexible yet firm piece of plastic, cardboard or other suitable material that acts as a base that is placed within retaining corners. This base acts as the portable easel and the rest of the art bag becomes a support for this portable easel which is held in position by the strap 32. The strap can be adjusted to one or more different positions to allow for various aperature angles that allow for an artist to work with different media in different environments.

FIG. 6a shows an alternative embodiment that can hold a whole book of paper with various holders for pencils and chalks for sketching. The paper or a drawing pad can be placed in the art pack for drawing with the drawing pad opened so the drawing can occur. FIG. 6b shows a setup for oils and/or acrylics and it could just as easily contain pastels, colored pencils or other artist materials and medium.

The portable art pack in FIG. 3 is set up as a watercolor set-up where the paper being used for the watercolor study is clipped to the base that sits in the easel portion of the portable art pack. All of the materials that are shown here, including the water bottle, paint brushes, and papers, can be carried in the portable art pack and removed as necessary to be used in a field location. Thus an artist can sketch on one side using a first easel side and paint using a second easel side having all the equipment for doing so within convenient reach yet easily able to be stored in a easily transportable means as shown in FIG. 2.

FIG. 4 shows another leaf of the art pack where other compartments hold bottles and other curios for artist. Papers could be held in many pockets as discussed above so that they are secured and protected. FIG. 5 shows pencils and other artists supplies stored in various compartments that can be connected by Velcro or other means to the portable art pack. These mini packets can be removed to be used separately and where some of the mini packets can be placed on the art pack. These holders 46 and pouches 48 would be located any of the leaves or other parts of the portable art package as discussed above.

The artist field pack or portable art pack, is designed for the traveling artist when it is not convenient to transport lots of equipment. When carefully outfitted, this portable art pack accommodates all that is needed for quick and convenient field-work, or a study, for any artist in the field. It is small and compact and can hold a set of watercolors, pastels, oils, or acrylics, as well as drawing pencils, drawing paper and other supplies that can be transported in this portable art pack or tote. The fact that this portable art pack can be made into two handy table or lap easels makes the portable art pack especially useful for any artist.

Completely outfitted with all the supplies that are shown in the first embodiment, the portable art pack in the embodiment shown in FIG. 2 weighs less than 5½ pounds. It can be easily carried and will fit into a suitcase for transportation to other parts of the country or world. It has proven to be a perfect solution for the artist on the go. It is important to note that an artist will be more inclined to transport art materials needed on a trip when they are all together in one case. This makes the trip more convenient and all activities more efficient for the artist. For most artists practicing in the field, it is necessary to travel with a minimum of equipment and supplies, and this invention makes that possible.

The portable art pack or field pack in this embodiment is made from a heavy, medium, or light grade canvas. This embodiment makes the portable art pack 10 that is approximately 12×14, ⅝″ folded and 14⅝″ by 24½″ open and flat and 14⅝″×12½″ set up as an easel. As shown in FIG. 2, the portable art pack 10 includes a handle and an adjustable, removable shoulder strap. It is made to outfit with an individual artist supplies and opens to spine into an A-frame easel, one side for drawing the other side for painting. A single strap snapped underneath, from the back panel to the front, holds the easel in place when the artist is working.

The front outside cover pocket is approximately 8½″×12″ and holds paper. Underneath this cover are pockets for art supplies, one pocket has a flap, and this pocket is 5″×8″, another pocket will accommodate a watercolor field set up to 1″×4.5″×8.5″ and can be held in place by a cover or snapable piece. Brushes, pencils and other supplies fit in a removable holder. Folded, this mini-compartment or caddie is 4½″×10″ and attaches to the field pack with Velcro or other connectors that are removable. When open this caddie is 14″×10″ and has protective flaps which open out. There are six pockets for pencils, five for brushes and a pocket that is 3.5″×6″ for extra pencils, brushes or other supplies. The fact that this is a removable caddie or mini-compartment is very helpful for a working field artist.

The back outside cover has four pockets for supplies such as a small water spray bottle, rags or other artist equipment, etc., and a protective flap spine over the pocket. Underneath is a 9½″×12″ pocket for paper.

The painting easel shown in this embodiment is a vinyl-backed painting surface that is 9″×12″ with paper secured under the four canvas corners. A banker-type clip can be inserted under the vinyl for extra holding power or to fasten smaller pieces of paper as shown in the drawings. The drawing easel holds tablets up to 9″×12″ which can fit this ease. Pages are held in place under two canvas corners or with the banker-type clips discussed above. When the pack is closed, the surrounding flaps snap front and back sections together. Extra paper and towels can be carried inside the folded pack. The strap that functions as the easel's brace can be wrapped around to the front and then fastens under the pocket when the pack it is closed. All an artist will need for a field trip is in this pack. The artist can do field sketching, as well as drawing and painting, and this pack fits easily in a suitcase for convenient travel.

The invention has been described in detail with particular reference to certain preferred embodiments thereof. It will be understood that variations and modifications can be affected within the spirit and scope of the present invention.

1. A portable art pack comprising:
(a) a body with a continuous peripheral wall, the body having an internal side and external side, and two leaves joined at a spine such that the art pack can be folded between a first storage position and a second upright position capable of forming an easel; and
(b) one closure flap extending from the first leaf to the second leaf with a first and a second position, the first position to maintain the leaves in the first closed position and the second position to maintain the leaves in a second upright position such that the closure flap limits the aperature between the leaves to less then 180 degrees.

2. The closure flap of claim 1 further adjustable between 40 degrees and 120 degrees.

3. The portable art pack of claim 1 further comprising:
(c) a second layer having at least one leaf joined to at least one other leaf such that the art pack can be folded between a first storage position and a second supporting, upright position; and
(d) the closure flap extending from the first leaf to another leaf with a first and second position, the first position to maintain the leaves in a first closed position and the second position to maintain the leaves in a second upright position such that the leaves form an angle about a spine line of less then 180 degrees.

4. The portable art pack of claim 1 further comprising one or more openings.

5. The portable art pack of claim 1 further comprising multiple attachment locations to create various aperatures.

6. The portable art pack of claim 1 further comprising detachable holders.

7. The portable art pack of claim 1 further comprising a rigid insert in the easel portion that is exposed in the second position but covered in the first position.

8. The portable art pack of claim 1 further comprising gussets in the easel portion that are exposed in the second position but covered in the first position.

9. The portable art pack of claim 1 further comprising an opening flap in the easel portion that is exposed in the second position but covered in the first position.

10. A portable art pack comprising:
(a) a body with a continuous peripheral wall, the body having an internal side and an external side and two leaves joined at a spine such that the art pack can be folded between a first storage position and a second upright position capable of forming an easel;
(b) a second layer having at least one leaf joined to at least one other leaf such that the art pack can be folded between a first storage position and a second upright position capable of forming an easel; and
(c) a closure flap extending from the first leaf to another leaf with a first and second position, the first position to maintain the leaves in a first closed position and the second position to maintain the leaves in a second upright position such that the leaves form an angle about a spine line of less then 180 degrees.

11. The closure flap of claim 10 further adjustable between 10 degrees and 140 degrees.

12. The portable art pack of claim 10 further comprising one or more detachable holder.

13. The portable art pack of claim 10 further comprising one or more releasable holders.

14. The portable art pack of claim 10 further comprising multiple attachment locations to create various aperatures.

15. A method of making a portable art pack comprising:
(a) preparing two leaves having a continuous peripheral wall with an internal side and an external side, the two leaves connected at a spine such that the art pack can be folded between a first storage position and a second, upright position capable of forming an easel; and
(b) attaching one closure flap extending from the first leaf to the second leaf with a first and second position, the first position to maintain the leaves in a first closed position and the second position to maintain the leaves in a second upright position such that the closure flap limits the angle between leaves to less then 180 degrees.

16. The method of making the portable art pack of claim 15 further comprising attaching a third leaf to the other two leaves such that the art pack can be folded between a first parallel/storage position capable of being stored away as a pack and a second supporting, upright position capable of forming an easel.

17. The method of claim 15 further comprising adding additional attachment locations that allow the closure flap to be attached in various positions between 10 degrees and 140 degrees.

18. The method of claim 15 where in these positions are continuous and include all angles between 10 degrees and 140 degrees.

19. The method of claim 15 wherein the art pack is made from one piece.

20. The method of claim 15 wherein the leaves are detachable.
